(19) United States
(12) Patent Application Publication
(10) Pub. No.: US 2025/0146715 A1
(43) Pub. Date: May 8, 2025

(54) HEAT UTILIZATION SYSTEM AND HEAT GENERATING DEVICE

(71) Applicant: CLEAN PLANET INC., Tokyo (JP)

(72) Inventors: Yoshito Endo, Tokyo (JP); Yasuhiro Iwamura, Miyagi (JP); Takehiko Itoh, Tokyo (JP); Hideki Yoshino, Tokyo (JP)

(73) Assignee: CLEAN PLANET INC., Tokyo (JP)

(21) Appl. No.: 18/684,366

(22) PCT Filed: Dec. 13, 2022
(86) PCT No.: PCT/JP2022/045815

§ 371 Date: Feb. 16, 2024

(30) Foreign Application Priority Data
Jan. 31, 2022 (JP) 2022-013772

(51) Int. Cl. F24V 30/00; F17C 11/00

(52) U.S. Cl. CPC F24V 30/00; F17C 11/005

(57) ABSTRACT

A heat utilization system includes: a heat generating device of one aspect of the invention, includes: a heat generating device including a heat-generating element configured of a multilayer film for generating heat by occlusion and discharge of hydrogen, a heating unit for heating the heat-generating element, and a sealed container for containing the heat-generating element and the heating unit; and a heat utilization device for utilizing a heat medium heated by the heat generating device as a heat source. The heat generating device is configured to be attachable and detachable with respect to the heat utilization device.

### TECHNICAL FIELD

The present invention relates to a heat utilization system and a heat generating device.

### BACKGROUND ART

It is known that a hydrogen storage alloy has properties of repeatedly occluding and discharging a large amount of hydrogen in a certain reaction condition, and is accompanied with significant reaction heat when occluding and discharging hydrogen. Various aspects of a heat utilization system and a heat generating device utilizing such reaction heat have been proposed (PTL 1).

According to a technology disclosed in PTL 1, in a heat utilization system in which a heat generating device is connected to a heat utilization device, a heat-generating element using a hydrogen storage alloy is enclosed in a container in which vacuum evacuation and hydrogen supply are available. A hydrogen occluding step of occluding hydrogen to the metal by supplying the hydrogen to the container, and a hydrogen discharging step of discharging the hydrogen from the hydrogen storage alloy by performing the vacuum evacuation of the container and the heating of the hydrogen storage alloy with a heater are executed. In the hydrogen discharging step, the heat generating device generates excess heat in an amount greater than a heating amount of the heater.

### CITATION LIST

### Patent Literature

PTL 1: WO2020/122097

### SUMMARY OF INVENTION

### Technical Problem

According to the technology disclosed in PTL 1, the heat generating device is configured such that the vacuum evacuation and the hydrogen supply can be executed in the state of being connected to the heat utilization device, and thus, there is a problem that the configuration of the heat generating device is complicated.

An object of the invention is to provide a heat utilization system for simplifying the configuration of a heat generating device, and a heat generating device.

### Solution to Problem

A heat utilization system utilizing a heat generating device of one aspect of the invention, includes: a heat generating device including a heat-generating element comprising a multilayer film for generating heat by occlusion and discharge of hydrogen, a heating unit for heating the heat-generating element, and a sealed container for containing the heat-generating element and the heating unit; and a heat utilization device for utilizing a heat medium heated by the heat generating device as a heat source. The heat generating device is attachable and detachable with respect to the heat utilization device.

A heat generating device of one aspect of the invention, includes: a heat-generating element comprising a multilayer film for generating heat by occlusion and discharge of hydrogen; a heating unit for heating the heat-generating element; and a sealed container for containing the heat-generating element and the heating unit. The heat generating device is attachable and detachable with respect to a heat utilization device utilizing a heat medium heated by the heat-generating element as a heat source.

### Advantageous Effects of Invention

According to the heat utilization system of one aspect of the invention, when a hydrogen discharging step is performed in the sealed container while the heat generating device is attached to the heat utilization device, the heat-generating element heated by the heating unit generates heat. After that, when hydrogen occluded in the multilayer film of the heat-generating element is discharged, and a heat generation amount decreases, the heat generating device is detached from the heat utilization device in order for regeneration, and in the detached, a hydrogen occluding step of occluding again hydrogen in the multilayer film is performed. As described above, in the heat utilization system and the heat generating device, an intake and exhaust system relevant to hydrogen supply and vacuum evacuation is not required, and thus, the configuration of the heat generating device can be simplified.

### BRIEF DESCRIPTION OF DRAWINGS

FIG. 1 is a perspective view of a heat generating cell used in a heat generating device according to the invention.

FIG. 2 is an enlarged cross-sectional view taken along line A-A in FIG. 1.

FIG. 3 is an enlarged detail view of a part B in FIG. 2 illustrating a configuration of a multilayer film of the heat generating cell.

FIG. 4 is a schematic view illustrating a mechanism in which excess heat is generated in the multilayer film of the heat generating cell.

FIG. 5 is an exploded perspective view of a heat utilization system utilizing a heat generating device of a first embodiment.

FIG. 6 is a cross-sectional view in a direction perpendicular to an axial direction of the heat utilization system.

FIG. 7 is a cross-sectional view in a plane including an axis of the heat utilization system.

FIG. 8 is an exploded perspective view of a heat utilization system utilizing a heat generating device of a second embodiment.

FIG. 9 is a cross-sectional view in a direction perpendicular to an axial direction of the heat utilization system.

FIG. 10 is a cross-sectional view in a plane including an axis of the heat utilization system.

### DESCRIPTION OF EMBODIMENTS

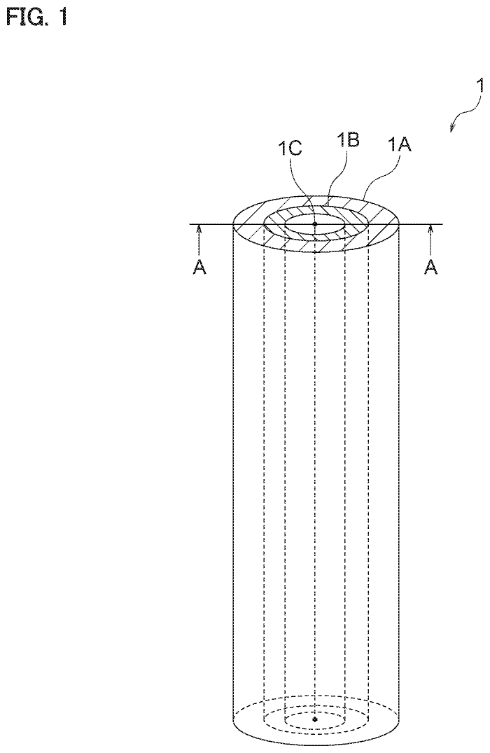

Hereinafter, embodiments of the invention will be described with reference to the drawings. First, by using FIG. 1 to FIG. 4, the configuration and a heat generating mechanism of a heat generating cell common to the embodiments of the present application will be described.

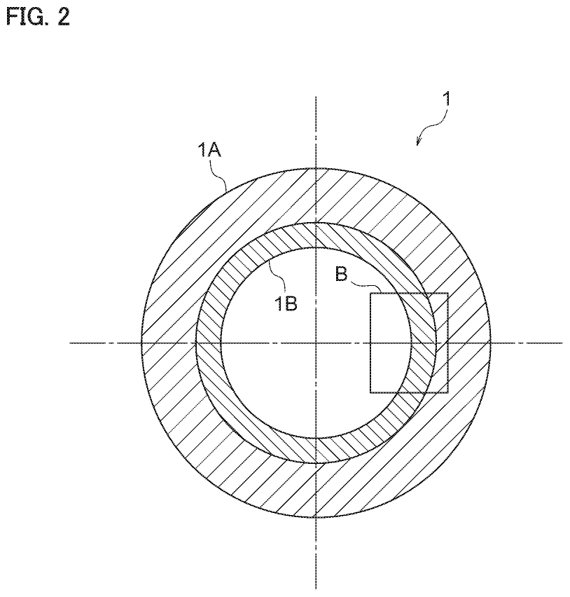

FIG. 1 is a perspective view of a heat generating cell according to the invention, and FIG. 2 is an enlarged cross-sectional view taken along line A-A in FIG. 1. A heat generating cell 1, which is illustrated, has a structure in which a multilayer film 1B for generating heat by the occlusion and the discharge of hydrogen is formed on the inner peripheral surface of a cylindrical (round pipe-shaped) support 1A formed of a porous metal sintered compact, a porous ceramic sintered compact, or a metal. Here, a plurality of pores having a size allowing hydrogen to permeate therethrough are formed in the porous metal sintered compact or the porous ceramic sintered compact for forming the support 1A. A material that does not inhibit a heat generating reaction between the hydrogen and the multilayer film 1B is used in the porous metal sintered compact or the porous ceramic sintered compact.

Specifically, in the porous metal sintered compact, for example, Ti, SUS, Mo, and the like are used, and in the ceramic sintered compact, for example, Al₂O₃, MgO, Cao, and the like are used. As the metal for forming the support 1A, for example, stainless steel (SUS) may be used. A heater 1C for heating the heat generating cell 1 (the multilayer film 1B) from the inside is provided inside the multilayer film 1B.

In this embodiment, the cylindrical (round pipe-shaped) support is used as the support 1A, and a polygonal tubular (square pipe-shaped) support may be used.

The hydrogen includes hydrogen-based gas containing an isotope of the hydrogen, and as the hydrogen-based gas, either deuterium gas or protium gas is used. The protium gas contains a mixture of naturally occurring protium and deuterium, that is, a mixture in which the ratio of the protium is 99.985%, and the ratio of the deuterium is 0.015%. In the following description, gas containing the hydrogen-based gas will be collectively referred to as “hydrogen”.

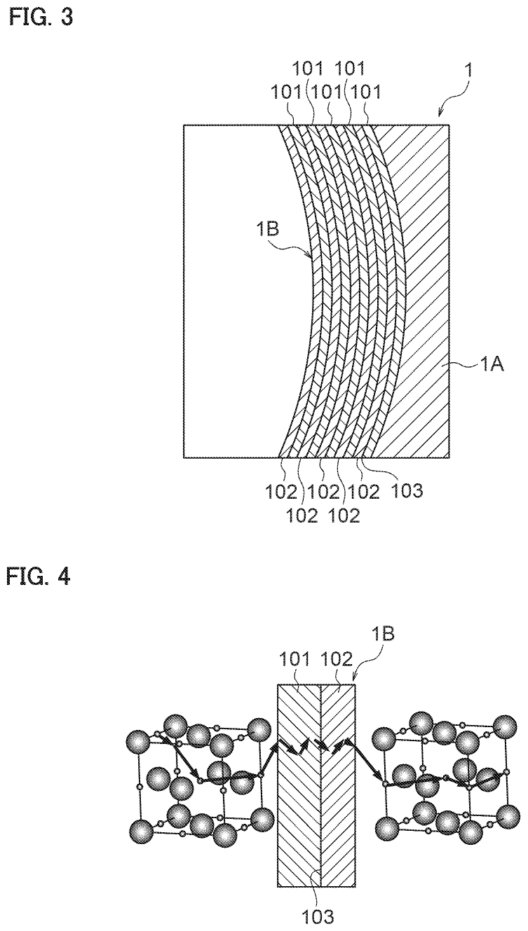

Here, the configuration of the multilayer film 1B will be described on the basis of FIG. 3.

FIG. 3 is an enlarged detail view of a part B in FIG. 2. In this embodiment, the multilayer film 1B formed on the inner peripheral surface of the support 1A illustrated in the same drawing includes a first layer 101 formed of a hydrogen storage metal or a hydrogen storage alloy, and a second layer 102 formed of a hydrogen storage metal or a hydrogen storage alloy, which is different from that of the first layer 101, or ceramics, and a heterogeneous material interface 103 is formed between the first layer 101 and the second layer 102. In the example illustrated in FIG. 3, the multilayer film 1B is formed as a film structure of a total of 10 layers by alternately stacking five first layers 101 and five second layers 102 in this order on the inner peripheral surface of the support 1A. The number of first layers 101 and second layers 102 is arbitrary, and unlike the example illustrated in FIG. 3, the multilayer film may be formed by alternately stacking a plurality of second layers 102 and a plurality of first layers 101 in this order on the inner peripheral surface of the support 1A. The multilayer film 1B includes at least one or more first layers 101 and at least one or more second layers 102, and one or more heterogeneous material interfaces 103 formed between the first layer 101 and the second layer 102 may be provided.

Here, the first layer 101, for example, is made of any one of Ni, Pd, Cu, Mn, Cr, Fe, Mg, Co, and an alloy thereof. Here, as the alloy for forming the first layer 101, an alloy made of two or more types of Ni, Pd, Cu, Mn, Cr, Fe, Mg, and Co is preferable. As the alloy for forming the first layer 101, an alloy obtained by adding additives to Ni, Pd, Cu, Mn, Cr, Fe, Mg, and Co may be used.

The second layer 102, for example, is made of any one of Ni, Pd, Cu, Mn, Cr, Fe, Mg, Co, and an alloy thereof, or SiC. Here, as the alloy for forming the second layer 102, an alloy made of two or more types of Ni, Pd, Cu, Mn, Cr, Fe, Mg, and Co is preferable. As the alloy for forming the second layer 102, an alloy obtained by adding additives to Ni, Pd, Cu, Mn, Cr, Fe, Mg, and Co may be used.

A combination of the first layer 101 and the second layer 102 is preferably Pd—Ni, Ni—Cu, Ni—Cr, Ni—Fe, Ni—Mg, or Ni—Co when the types of elements are expressed as “First Layer-Second Layer”. When the second layer 102 is made of ceramics, a combination of Ni—SiC is desirable.

In the example illustrated in FIG. 1 to FIG. 3, the multilayer film 1B provided inside the support 1A is formed of the first layer 101 and the second layer 102, but is not limited thereto. The multilayer film 1B may further include a third layer. The third layer is made of a hydrogen storage metal, a hydrogen storage alloy, or ceramics, which is different from that of the first layer 101 and the second layer 102. The multilayer film 1B may include one or more third layers.

The multilayer film 1B provided inside the support 1A may further include a fourth layer, in addition to the first layer 101, the second layer 102, and the third layer. The fourth layer is made of a hydrogen storage metal, a hydrogen storage alloy, or ceramics, which is different from that of the first layer 101, the second layer 102, and the third layer. As with the third layer, the multilayer film 1B may include one or more fourth layers.

Here, a mechanism by which the heat generating cell 1 generates heat (generates excess heat) will be described on the basis of FIG. 4.

FIG. 4 is a schematic view illustrating the mechanism of excess heat generation in the heat generating cell. The heterogeneous material interface 103 formed between the first layer 101 and the second layer 102 of the multilayer film 1B of the heat generating cell 1 allows hydrogen atoms to permeate therethrough. When hydrogen is supplied to the heat generating cell 1 from the inner peripheral surface side, the first layer 101 and the second layer 102 having a face-centered cubic structure, that is, the multilayer film 1B occludes the hydrogen. Here, even when the supply of the hydrogen is stopped, the heat generating cell 1 maintains a state where the hydrogen is occluded by the multilayer film 1B.

When heating is started by the heater 1C of the heat generating cell 1, as illustrated in FIG. 4, hydrogen atoms in a metal lattice of the first layer 101 permeate through the heterogeneous material interface 103 to move into a metal lattice of the second layer 102, the hydrogen occluded in the multilayer film 1B is discharged, and the hydrogen is quantum-diffused while hopping inside the multilayer film 1B. Here, it is known that hydrogen is light, and hydrogen atoms are quantum-diffused while hopping a site (an octahedral or tetrahedral site) occupied by hydrogen of certain substance A and substance B. Accordingly, by heating the heat generating cell 1 with the heater 1C, the hydrogen permeates through the heterogeneous material interface 103 by quantum diffusion, or the hydrogen permeates through the heterogeneous material interface 103 by diffusion, and thus, the heat generating cell 1 generates heat, and heat with a heat quantity greater than or equal to a heating amount by the heater 1C is generated as excess heat.

It is desirable that the thickness of each of the first layer 101 and the second layer 102 in the multilayer film of the heat generating cell 1 is less than 1000 nm. When the thickness of each of the first layer 101 and the second layer 102 is less than 1000 nm, the first layer 101 and the second layer 102 can maintain a nano-structure that does not exhibit bulk properties. When the thickness of each of the first layer 101 and the second layer 102 is 1000 nm or more, it is difficult for the hydrogen to permeate through the multilayer film 1B. It is desirable that the thickness of each of the first layer 101 and the second layer 102 is less than 500 nm. As described above, when the thickness of each of the first layer 101 and the second layer 102 is less than 500 nm, the first layer 101 and the second layer 102 can maintain the nano-structure that does not completely exhibit the bulk properties.

Here, an example of a method for producing the heat generating cell 1 will be described.

The heat generating cell 1 is produced by preparing the cylindrical (round pipe-shaped) support 1A, setting a hydrogen storage metal or a hydrogen storage alloy to be the first layer 101 or the second layer 102 in a gas phase state by a vapor deposition equipment while rotating the support 1A around the axis, and alternately forming the first layer 101 and the second layer 102 on the inner peripheral surface of the support 1A by the aggregation or the adsorption of the hydrogen storage metal or the hydrogen storage alloy in the gas phase state. In this case, it is preferable to continuously form the first layer 101 and the second layer 102 in a vacuum state, and thus, the heterogeneous material interface 103 is formed between the first layer 101 and the second layer 102 without forming a natural oxide film.

As the vapor deposition equipment, a physical vapor deposition equipment vapor-depositing the hydrogen storage metal or the hydrogen storage alloy by a physical method is used, and as the physical vapor deposition equipment, a sputtering device, a vacuum vapor deposition equipment, or a chemical vapor deposition (CVD) equipment are used. The first layer 101 and the second layer 102 may be alternately formed by precipitating the hydrogen storage metal or the hydrogen storage alloy on the inner peripheral surface of the support 1A by an electroplating method.

### First Embodiment

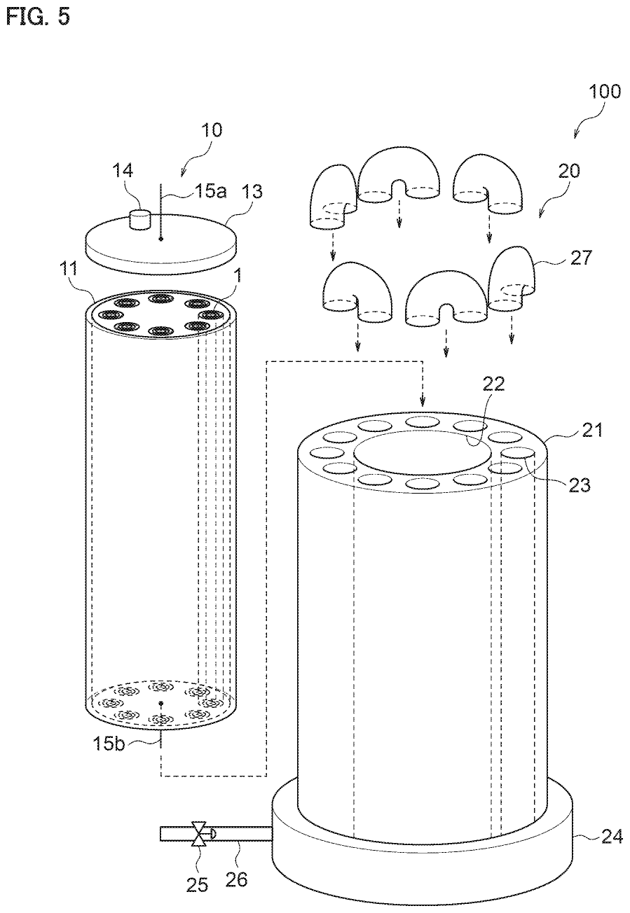

Next, a heat utilization system of a first embodiment will be described by using FIG. 5 to FIG. 7. Hereinafter, the description will be made using up, down, left, and right directions in the drawings, but the disposition of the heat utilization system is not limited to those directions, and the heat utilization system can be disposed in any direction. The multilayer film 1B of the heat generating cell 1 is an example of a heat-generating element, and the heater 1C is an example of a heating unit.

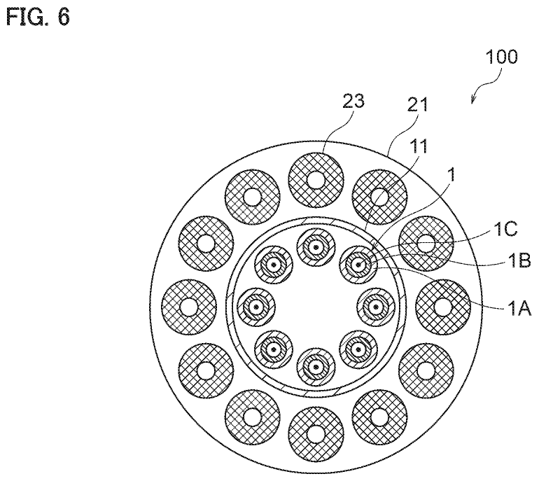

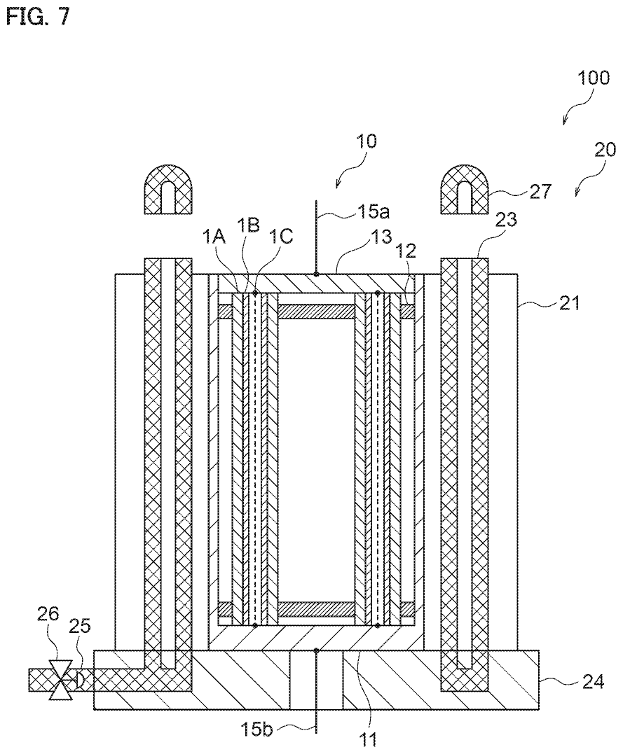

The heat utilization system has a structure in which a columnar heat generating device including the heat generating cell 1 is loaded into a columnar heat utilization device. FIG. 5 is an exploded perspective view of the heat utilization system utilizing the heat generating device. FIG. 6 is a cross-sectional view in a direction perpendicular to an axial direction of the heat utilization system, and FIG. 7 is a cross-sectional view in a plane including the axis of the heat utilization system.

As illustrated in FIG. 5, a heat utilization system 100 includes a columnar heat generating device 10 including the heat generating cell 1, and a columnar heat utilization device 20 that uses the heat generating device 10 as a heat source and has a diameter larger than that of the heat generating cell 1. The aspect of the heat generating device 10 and the heat utilization device 20, which are illustrated, is an example, and the heat generating device and the heat utilization device can be configured in various shapes such as a square column.

In the heat generating device 10, a plurality of (in the example of this drawing, eight) columnar heat generating cells 1 are disposed inside a bottomed columnar housing 11 including an opening on an upper surface. In FIG. 5, for readability, the outline of the lateral surface and the inner surface of the heat generating cell 1 only on the rightmost side in the drawing, which is contained in the housing 11, is illustrated by a broken line, and only the upper and lower end surfaces of the other seven heat generating cells 1 are illustrated. As illustrated in the cross-sectional view of FIG. 7, a holder 12 for retaining the heat generating cell 1 is provided inside the housing 11.

The opening in the upper portion of the housing 11 in the drawing is blocked by a lid 13. A sealed container is formed by the housing 11 and the lid 13, and the lid 13 corresponds to an opening-closing portion of the sealed container. The sealed container (the housing 11 and the lid 13) is configured as a replaceable cartridge-type container, and is replaceably loaded into the heat utilization device 20 of the heat utilization system 100.

In the lid 13, an intake and exhaust port 14 including an openable and closable valve is provided. The intake and exhaust port 14 is used for vacuum evacuation and hydrogen filling in the housing 11 when regenerating a cartridge-type heat generating device 10. While the heat generating device 10 is loaded into the heat utilization device 20, the intake and exhaust port 14 remain closed without being opened. Electrodes 15a and 15b are provided on the upper surface of the lid 13 and the bottom surface of the housing 11, respectively. Electric wiring is provided in the lid 13, and the electrodes 15a and 15b are electrically connected to the heaters 1C of each of the heat generating cells 1 through the electric wiring. As a result thereof, power is supplied to the heater 1C through the electrodes 15a and 15b, and thus, the heater 1C can be heated.

The inside of the sealed container (the housing 11 and the lid 13) is filled with hydrogen-based gas, and hydrogen contained in the hydrogen-based gas is occluded in the multilayer film 1B of the heat generating cell 1. The multilayer film 1B is heated by the heater 1C, and thus, the hydrogen occluded in the multilayer film 1B is discharged. Excess heat is generated through occlusion and discharge of the hydrogen.

In this embodiment, while the heat generating device 10 is mounted on the heat utilization device 20, a hydrogen discharging step is performed in the sealed container (the housing 11 and the lid 13) of the heat generating device 10. In the hydrogen discharging step, when the heat generating cell 1 is heated by the heater 1C, the excess heat is discharged in accordance with the discharge of the hydrogen occluded in the multilayer film 1B. After that, when the hydrogen occluded in the multilayer film 1B is discharged, the heat generating device 10 is detached from the heat utilization device 20 in order for regeneration. In the detached heat generating device 10, a hydrogen occluding step of occluding the hydrogen in the multilayer film 1B is performed. In the hydrogen occluding step, the sealed container is filled with the hydrogen-based gas, and the hydrogen is occluded in the multilayer film 1B, and then, the sealed container is vacuum-evacuated. After occluding the hydrogen, the multilayer film 1B maintains a state where the hydrogen is occluded even when vacuum-evacuated, and thus, the heat generating device 10 is regenerated. The vacuum evacuation may be arbitrarily and additionally performed even before filling the container with the hydrogen-based gas. When the vacuum evacuation is not performed before filling the container with the hydrogen-based gas, in the hydrogen occluding step, hydrogen supplied from outside the sealed container is occluded in the multilayer film 1B. When the vacuum evacuation is performed before filling the container with the hydrogen-based gas, the hydrogen that is discharged in the hydrogen discharging step and accumulated in the sealed container is occluded in the multilayer film 1B together with the hydrogen supplied from outside the sealed container.

When the support 1A is formed of the porous metal sintered compact or the porous ceramic sintered compact, the hydrogen in the sealed container (the housing 11 and the lid 13) reaches the multilayer film 1B in the support 1A even when the upper and lower end surfaces of the heat generating cell 1 are blocked by being in contact with the inner surfaces of the lid 13 and the housing 11, and the hydrogen occlusion of the multilayer film 1B is available. The support 1A may be formed of a metal such as stainless steel (SUS), and in this case, the upper and lower end surfaces of the heat generating cell 1, and the inner surfaces of the housing 11 and the lid 13 are separated from each other, the outer diameter side of the support 1A and the inner diameter side of the multilayer film 1B are communicated with each other through the separated portion, and the hydrogen occlusion of the multilayer film 1B is available.

The heat generating device 10 can be regenerated by the hydrogen occluding step in the state of being detached from the heat utilization device 20 as described above, but by repeating the heat generating reaction, the heat generating cell 1 in the heat generating device 10 can be aged. In such a case, by replacing the entire heat generating device 10, it is possible to perform the maintenance of the heat utilization system 100. The heat generating device 10 detached from the heat utilization device 20 is regenerated by performing the hydrogen occluding step (the vacuum evacuation and the hydrogen filling) through the intake and exhaust port 14 after opening the lid 13 and replacing the heat generating cell 1 inside. The intake and exhaust port 14 is an example of an openable and closable opening provided on the sealed container (the housing 11 and the lid 13).

The heat utilization device 20 includes a hollow columnar housing 21, and the columnar heat generating device 10 is loaded into a center hollow portion 22. A plurality of (in this drawing, twelve) conduits 23 through which a heat medium flows in the axial direction (in the drawing, an up and down direction) are provided on the outer periphery of the hollow portion 22. That is, the heat utilization device 20 includes the conduit 23 disposed around the heat generating device 10, through which the heat medium flows. In FIG. 5, for readability, the outline of the lateral surface of the conduit 23 only on the rightmost side in the drawing in the housing 21 is illustrated by a broken line, and only the end surfaces of the upper portions of the other eleven conduits 23 are illustrated. The conduit 23 may be retained by the holder inside the housing 21, or may be contained and fixed in the opening provided in the housing 21. In this embodiment, a hollow is provided inside the housing 21, and a gas (for example, the air) is enclosed in the hollow. The inner wall of the housing 21 and the outer wall of the conduit 23 are separated from each other such that the conduit 23 and the heat generating device 10 are not in contact with each other. The housing 21 is disposed on a base portion 24, an outflow and inflow path 26 of the heat medium, which includes a valve 25, is provided on the base portion 24. The outflow and inflow path 26 includes both of an inflow path of the heat medium to the heat utilization device 20, and an outflow path of the heat medium from the heat utilization device 20.

As the heat medium, a gas or a liquid can be used, and a heat medium having an excellent heat conductivity and chemical stability is preferable. As the gas, for example, helium gas, argon gas, hydrogen gas, nitrogen gas, water vapor, the air, carbon dioxide, and the like are used. As the liquid, for example, water, a molten salt (KNO₃ (40%)-NaNO₃ (60%) or the like), a liquid metal (Pb or the like), and the like are used. As the heat medium, a multiphase heat medium in which solid particles are dispersed in a gas or a liquid may be used. The solid particles are a metal, a metal compound, an alloy, ceramics, and the like. As the metal, copper, nickel, titanium, cobalt, and the like are used. As the metal compound, an oxide, a nitride, a silicide, and the like of the metal described above are used. As the alloy, stainless steel, chrome molybdenum steel, and the like are used. As the ceramics, alumina and the like are used. In this example, as the heat medium, a gas such as helium gas is used.

Two adjacent conduits 23 form a pair, and end portions on the upper side in the drawing are connected by a U-shaped linking portion 27. The flow of the heat medium in a pair of conduits 23 is as follows. The heat medium flows in from an inflow port of one conduit 23 in the base portion 24, and then, flows toward the linking portion 27 side from the base portion 24 side in one conduit 23. After that, the heat medium flows in the other conduit 23 through the linking portion 27, flows toward the base portion 24 from the linking portion 27 in the other conduit 23, and flows out from the outflow port of the other conduit 23 in the base portion 24.

In the base portion 24, for a plurality of pairs of conduits 23, the inflow port of one conduit 23 of each pair of conduits is connected to the inflow path of the outflow and inflow path 26, and the outflow port of the other conduit 23 is connected to the outflow path of the outflow and inflow path 26. According to such a configuration, the heat medium flowing in the heat utilization device 20 from the inflow path of the outflow and inflow path 26 is heated by the heat generating device 10 in the conduit 23, and then, is discharged from the outflow path of the outflow and inflow path 26.

As illustrated in FIG. 7, the base portion 24 includes an opening penetrating in the axial direction in the center, and the electrode 15b is provided through the opening. When the heat generating device 10 is attached and detached with respect to the heat utilization device 20, electrical connection and disconnection between the heater 1C (the heating unit) and a power supply source is performed through the electrodes 15a and 15b. When the heat generating device 10 is attached to the heat utilization device 20, electrical connection between the electrodes 15a and 15b of the heat generating device 10 and the power supply source outside the heat generating device 10 may be performed. The power supply source may be provided in the heat utilization device 20, and may be provided outside the heat utilization system 100. The heat utilization device 20 does not include a device relevant to the vacuum evacuation or the hydrogen filling, and thus, when the heat generating device 10 is attached to the heat utilization device 20, the connection of an intake and exhaust system such as the vacuum evacuation or the hydrogen filling is not required.

The heat medium is not limited to the gas, and may be a liquid such as water. When the heat medium is water, it is possible to drive a boiler connected to the outflow and inflow path 26. However, when water is used as the heat medium, and water is vaporized by heating in the conduit 23 to generate water vapor, the volume increases sharply, and thus, the conduit 23 may be damaged. Accordingly, when water is used as the heat medium, the linking portion 27 is not provided, and all the conduits 23 are configured such that water, which is the heat medium, flows through the conduit toward the upper side from the lower side in a vertical direction in a portion where heat exchange with the heat generating device 10 is performed. According to such a configuration, even when the water vapor is generated in the conduit 23, the water vapor flows to the upper side by the own weight and a water flow, and thus, it is possible to reduce a concern that the conduit 23 is damaged.

As illustrated in the cross-sectional view of FIG. 6 and FIG. 7, the conduit 23 includes a hollow portion inside. The conduit 23 has a hollow structure. The conduit 23 may not include the hollow portion, and in this case, a flow rate is faster in the center portion than in the vicinity of the wall portion, and heat transfer to the heat medium may not be uniformized. The conduit 23 of this embodiment includes the hollow portion inside, and thus, the flow rate in the conduit is uniformized, and the heat exchange efficiency of the heat medium can be improved. As described above, in the conduit 23, the heat medium is heated by convection, heat transfer, radiation, and the like. For example, when the conduit is in the shape of a spiral, and a precipitate is generated on the inner wall of the conduit, it is difficult to remove the precipitate, but it is comparatively easy for the linear conduit 23 to remove the precipitate.

The conduit through which the heat medium flows is not limited to the linear conduit as described in this embodiment, and may be provided into the shape of a spiral along the outer periphery of the hollow portion into which the heat generating device is loaded. However, when the conduit is in the shape of a spiral, it is preferable to use a gas as the heat medium. In the spiral conduit, a difference in the flow rate between the inner side (the heat generating device side) and the outer side of the conduit is remarkable, and the difference in the flow rate increases when a liquid is used as the heat medium. As described above, in the spiral conduit, the flow rate of the heat medium is slower on the inner side than on the outer side in the conduit, and thus, the heat transfer is slowed, and the heat exchange efficiency may be degraded. Accordingly, when the heat medium is a liquid, it is preferable that the conduit is linear as with this embodiment but not spiral.

As described above, in this embodiment, while the heat generating device 10 is attached to the heat utilization device 20, the hydrogen discharging step is performed in the sealed container (the housing 11 and the lid 13). In the hydrogen discharging step, when the heat generating cell 1 is heated by the heater 1C, the excess heat is discharged in accordance with the discharge of the hydrogen occluded in the multilayer film 1B. The heat medium flowing through the conduit 23 of the heat utilization device 20 is heated by using the excess heat in the hydrogen discharging step, and thus, a turbine or the like connected to the outflow and inflow path 26 can be operated.

After that, when the hydrogen occluded in the multilayer film 1B is discharged, and a heat generation amount decreases, in order to regenerate the heat generating device 10, the heat generating device 10 is detached from the heat utilization device 20. While the heat generating device 10 is detached from the heat utilization device 20, the hydrogen occluding step of occluding (occluding again) the hydrogen supplied from outside the sealed container (the housing 11 and the lid 13) in the multilayer film 1B is performed. As described above, in the heat utilization system 100, the intake and exhaust system relevant to the hydrogen supply or the vacuum evacuation is not required, and thus, it is possible to simplify the configuration of the heat generating device 10.

In the hydrogen occluding step, it is possible to occlude the hydrogen in the multilayer film 1B by using the hydrogen-based gas filling in the sealed container from the outside, in addition to the hydrogen discharged in the sealed container (the housing 11 and the lid 13) in the hydrogen discharging step. As described above, by occluding again the hydrogen discharged in the hydrogen discharging step in the multilayer film 1B in the hydrogen occluding step, the hydrogen can be used again in the sealed container, and thus, a hydrogen utilization efficiency is improved, and an operating cost can be reduced.

In general, when the hydrogen is in contact with the multilayer film 1B, the heat of the multilayer film 1B is absorbed in the hydrogen, and a heat utilization rate decreases. In contrast, in a state where the heat generating device 10 is attached to the heat utilization device 20, the sealed container (the housing 11 and the lid 13) is in a vacuum state, and the hydrogen is not supplied in the hydrogen discharging step. As a result thereof, the heat generated in the multilayer film 1B is not absorbed in the hydrogen in the sealed container, and thus, the heat utilization rate can be improved.

When the hydrogen occluding step is performed in a state where the heat generating device 10 is attached to the heat utilization device 20, the connection of the intake and exhaust system such as the vacuum evacuation or the hydrogen filling is required, and there is a concern that contamination due to the system occurs. When such environmental-origin contamination is attached to the surface of the multilayer film 1B of the heat generating cell 1, the surface of the multilayer film 1B is contaminated, a reaction area decreases, the heat generating reaction is inhibited, and the heat generation amount decreases. In contrast, in this embodiment, the heat generating device 10 is detached from the heat utilization system 100, and the hydrogen occluding step can be executed in an environment where the contamination is less likely to occur, and thus, a decrease in the heat generation amount due to surface contamination of the multilayer film 1B due to the environmental-origin contamination can be suppressed.

The heat generating device 10 is attachable and detachable with respect to the heat utilization device 20, and thus, when a plurality of heat generating devices 10 regenerated through the hydrogen occluding step are prepared in advance, the heat utilization system 100 can be restarted only by a replacement time of the heat generating device 10 after the hydrogen discharging step of the heat generating device 10 is ended. Accordingly, a time for stopping the operation of the heat utilization system 100 is shortened, and an operation efficiency can be improved.

During the operation of the heat generating device 10, the electrodes 15a and 15b are connected to the sealed container (the housing 11 and the lid 13), but the device for the vacuum evacuation or the hydrogen filling is not required. Accordingly, when the heat generating cell 1 is aged, and the heat generating device 10 mounted on the heat utilization device 20 is replaced, it is necessary to detach/connect again the electrodes 15a and 15b, but it is not necessary to detach/connect again the system for the vacuum evacuation or the hydrogen filling. For the detached heat generating device 10, the heat generating cell 1 is replaced by opening the opening-closing portion (the lid 13) of the sealed container, and then, the vacuum evacuation and the hydrogen filling are performed through the intake and exhaust port 14, and thus, the regeneration can be performed. As described above, the maintainability of the heat utilization system 100 is improved, and a maintenance cost can be reduced.

In this embodiment, in the columnar heat generating cell 1, the heater 1C is disposed at the center axis, but is not limited thereto. The heater 1C can be disposed at any position of the heat generating cell 1, and for example, may be disposed to be wound into the shape of a spiral along the outer periphery of the support 1A in the columnar heat generating cell 1. As another form, only one heater 1C may be provided in the center of the housing 11, and a plurality of heat generating cells 1 may be provided around the heater 1C. As described above, by heating the plurality of heat generating cells 1 with one heater 1C, the number of heaters 1C decreases, and thus, a production cost can be reduced.

In this embodiment, the inner wall of the housing 21 and the outer wall of the conduit 23 are separated from each other, such that the heat generating device 10 and the conduit 23 are not in contact with each other, and thus, the heat medium flowing into the conduit 23 is heated by the radiation of the heat generated by the heat generating device 10. As another aspect, when moving the conduit 23 to the inner side (the heat generating device side) of the housing 21 such that the heat generating device 10 and the conduit 23 are in contact with each other, the heat medium flowing into the conduit 23 is heated by heat transmission through the vacuum sealed container (the housing 11 and the lid 13) of the heat generating device 10.

### Second Embodiment

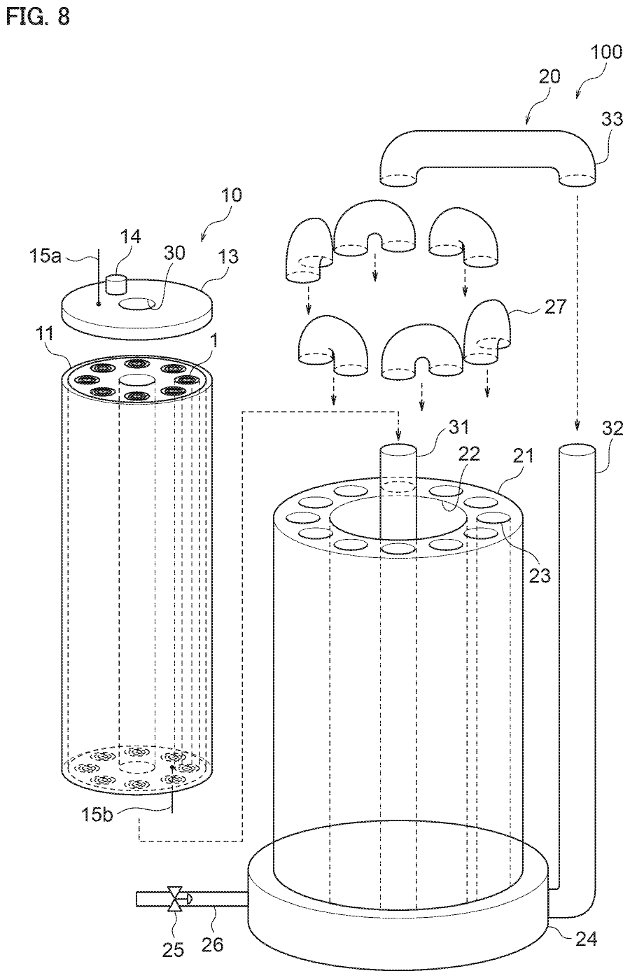

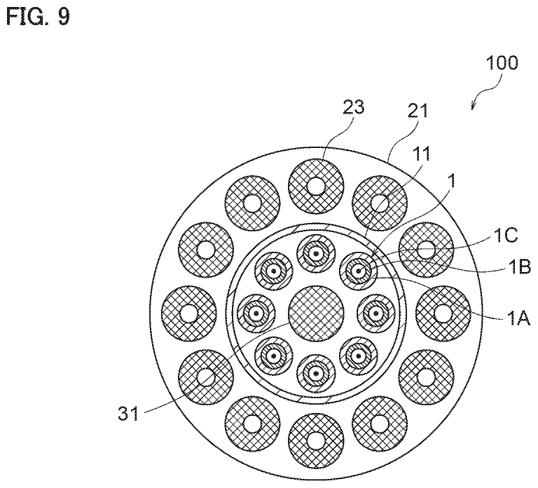

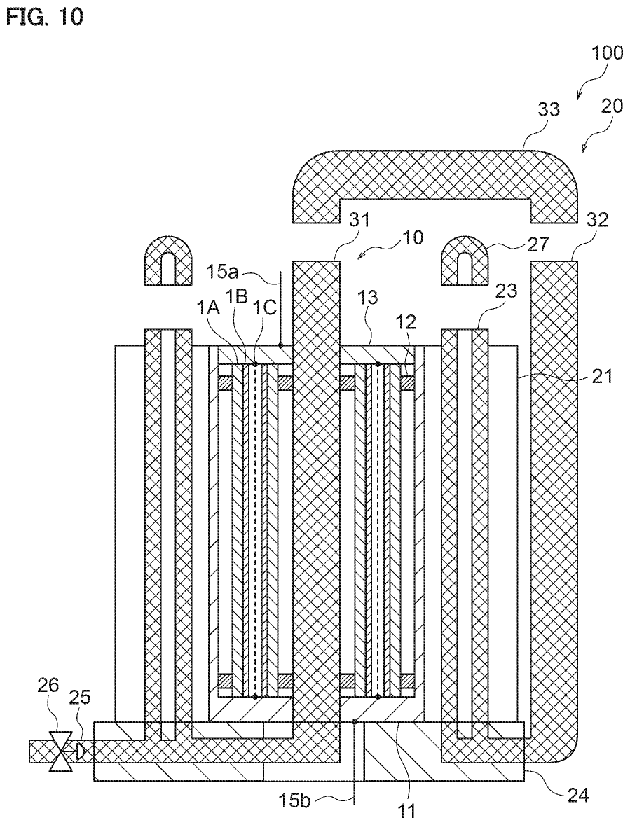

In a second embodiment, a different aspect of the housing 11 configuring the sealed container (the housing 11 and the lid 13) will be described. FIG. 8 is an exploded perspective view of a heat utilization system. FIG. 9 is a cross-sectional view in a direction perpendicular to an axial direction of the heat utilization system. FIG. 10 is a cross-sectional view in a plane including the axis of the heat utilization system. FIG. 8 to FIG. 10 correspond to FIG. 5 to FIG. 7 of the first embodiment, respectively.

As illustrated in such drawings, in the second embodiment, when comparing the sealed container (the housing 11 and the lid 13) of the heat generating device 10 with the sealed container (the housing 11 and the lid 13) of the first embodiment, a hollow portion 30 is configured inside. Specifically, the hollow portion 30 is formed by an opening provided in the center of the lid 13, and an opening provided in the center of the holder 12 in the housing 11. The sealed container (the housing 11 and the lid 13) of the second embodiment is in the shape of a column and includes an opening in the center. For readability, in FIG. 8, the outline of a center conduit 31 contained in the holder 12 in the center of the housing 11 is illustrated. The multilayer film 1B (the heat-generating element) of the heat generating cell 1 is in the shape of a column (in this example, a circular column). A plurality of multilayer films 1B (heat-generating elements) are disposed around the opening of the sealed container.

The heat utilization device 20 includes the center conduit 31 in the center of the hollow portion 22. In a state where the heat generating device 10 is loaded into the heat utilization device 20, the center conduit 31 is inserted into the hollow portion 30 of the heat generating device 10. The heat utilization device 20 includes an external conduit 32 outside the housing 21, and the center conduit 31 and the external conduit 32 are connected in the base portion 24 on the lower side and connected by a linking portion 33 on the upper side. The connection between the center conduit 31 and the external conduit 32 by the linking portion 33 is performed after the heat generating device 10 is loaded into the heat utilization device 20. Even in this embodiment, a gas is used as the heat medium. When a liquid is used as the heat medium, linking portions 27 and 33 are not provided, and the conduit 23 and the center conduit 31 are configured such that the liquid heat medium flows into the conduit 23 and the center conduit 31 toward the upper side from the lower side in a vertical direction. Accordingly, it is possible to reduce a concern that the conduit 23 and the center conduit 31 are damaged due to the vaporization of the liquid heat medium.

The heat medium flows in from an inflow port of the center conduit 31 in the base portion 24, and then, flows toward the linking portion 33 side from the base portion 24 side. After that, the heat medium flows in the external conduit 32 through the linking portion 33, flows toward the base portion 24 from the linking portion 33 in the external conduit 32, and flows out from an outflow port of the external conduit 32 in the base portion 24. In the base portion 24, the inflow port of the center conduit 31 is connected to the inflow path of the outflow and inflow path 26, and the outflow port of the external conduit 32 is connected to the outflow path of the outflow and inflow path 26.

The configuration of the center conduit 31 and the external conduit 32 is not limited to the example described above, and may have various aspects. The heat medium may flow toward the center conduit 31 from the external conduit 32. The center conduit 31 and the external conduit 32 may include a hollow portion inside, as with the conduit 23.

In the sealed container (the housing 11 and the lid 13), a plurality of heat generating cells 1 are arranged in a circumferential direction on a cross-sectional surface, and thus, the center portion is easily heated. The center conduit 31 may be further provided in the center portion of the sealed container, and thus, the heat medium can be efficiently heated.

The configuration of this embodiment is effective when the heat generating device 10 becomes larger and the center portion is at a high temperature. When the heat generating device 10 becomes larger, heat generated by each of the heat generating cells 1 interferes with each other, the temperature of the surface of the heat generating cell 1 abnormally increases, for example, to 950° C. or higher, and there is a concern that the support 1A and the multilayer film 1B are deformed. Therefore, the heat generating device 10 exchanges heat with the conduit 23 disposed on the outer periphery, and also exchanges heat with the center conduit 31, and thus, the abnormal increase in the temperature of the heat generating cell 1 can be suppressed, and the deformation of the support 1A and the multilayer film 1B can be prevented.

The invention may include various embodiments and modifications without departing from the broad spirit and the scope of the invention. The embodiments described above are for describing the invention, and do not limit the scope of the invention. The scope of the invention is indicated by the claims but not the embodiments. Various modifications made within the claims and within the range of the meaning of the invention equivalent to the claims are considered to be within the scope of the invention.

### REFERENCE SIGNS LIST

1: heat generating cell
1A: support
1B: multilayer film (heat-generating element)
1C: heater (heating unit)
10: heat generating device
11: housing
13: lid (opening-closing portion)
20: heat utilization device
23: conduit
31: center conduit
32: external conduit
100: heat utilization system

1. A heat utilization system, comprising:
a heat generating device including a heat-generating element comprising a multilayer film for generating heat by occlusion and discharge of hydrogen, a heating unit for heating the heat-generating element, and a sealed container for containing the heat-generating element and the heating unit; and
a heat utilization device for utilizing a heat medium heated by the heat generating device as a heat source,
wherein the heat generating device is attachable and detachable with respect to the heat utilization device.

2. The heat utilization system according to claim 1,
wherein while the heat generating device is attached to the heat utilization device, a hydrogen discharging step of discharging hydrogen occluded in the heat-generating element and causing excess heat by heating the heat-generating element with the heating unit is performed, and
while the heat generating device is detached from the heat utilization device, a hydrogen occluding step of occluding hydrogen supplied from outside the sealed container in the heat-generating element is performed.

3. The heat utilization system according to claim 1,
wherein the heating unit is driven in accordance with supply of power, and
when the heat generating device is attached and detached with respect to the heat utilization device, electrical connection and disconnection between the heating unit and a supply source of the power are performed.

4. The heat utilization system according to claim 1,
wherein the heat utilization device includes a conduit disposed around the heat generating device, through which the heat medium flows.

5. The heat utilization system according to claim 4,
wherein the conduit has a hollow structure.

6. The heat utilization system according to claim 5,
wherein when the heat medium is a liquid, the conduit is configured such that the heat medium flows from a lower side to an upper side in a vertical direction in a portion in which heat exchange with the heat generating device is performed.

7. The heat utilization system according to claim 4,
wherein in the heat generating device,
the sealed container is in the shape of a column and includes an opening in a center,
a plurality of heat-generating elements including the heat-generating element, each of the plurality of heat-generating elements is in the shape of a column, and the plurality of heat-generating elements are disposed around the opening, and
the heat utilization device further includes a center conduit penetrating through the opening of the heat generating device, through which the heat medium flows.

8. A heat generating device, comprising:
a heat-generating element comprising a multilayer film for generating heat by occlusion and discharge of hydrogen;
a heating unit for heating the heat-generating element; and
a sealed container for containing the heat-generating element and the heating unit,
wherein the heat generating device is attachable and detachable with respect to a heat utilization device utilizing a heat medium heated by the heat-generating element as a heat source.

9. The heat generating device according to claim 8,
wherein when the heat generating device is detached from the heat utilization device, a hydrogen occluding step of occluding hydrogen supplied from outside the sealed container in the heat-generating element is performed.

10. The heat generating device according to claim 8,
wherein the heat generating device includes an openable and closable opening provided on the sealed container, and
the openable and closable opening is closed when the heat generating device is attached to the heat utilization device, opened when the heat generating device is detached from the heat utilization device, and utilized for supplying hydrogen to the sealed container from the outside.

11. The heat generating device according to claim 8,
wherein the sealed container includes an opening-closing portion and is configured such that the heat-generating element can be replaced by opening the opening-closing portion.
